(19) United States
(12) Patent Application Publication
(10) Pub. No.: US 2024/0355030 A1
(43) Pub. Date: Oct. 24, 2024

(54) IMAGE PROCESSING METHOD AND APPARATUS, DEVICE, AND STORAGE MEDIUM

(71) Applicant: Beijing Zitiao Network Technology Co., Ltd., Beijing (CN)

(72) Inventor: Zhixiong LU, Beijing (CN)

(21) Appl. No.: 18/682,810

(22) PCT Filed: Jul. 7, 2022
(86) PCT No.: PCT/CN2022/104273

§ 371 Date: Feb. 9, 2024

(30) Foreign Application Priority Data
Aug. 9, 2021 (CN) 202110909034.2

(51) Int. Cl. G06T 13/60; G06T 7/12; G06V 10/60

(52) U.S. Cl. CPC G06T 13/60; G06T 7/12; G06V 10/60

(57) ABSTRACT

An image processing method and apparatus, a device, and a storage medium are provided. The image processing method includes: acquiring a target image, and acquiring attribute information of the sky in the target image; performing sky segmentation processing on the target image to obtain a sky image in the target image; and, on the basis of the attribute information, performing corresponding effect processing on the sky image in the target image. The corresponding effect processing step is selected based on the attribute information in order to perform effect processing on the sky image.

The present application claims priority of Chinese Patent Application No. 202110909034.2 filed to the China National Intellectual Property Administration on Aug. 9, 2021, entitled “IMAGE PROCESSING METHOD AND APPARATUS, DEVICE, AND STORAGE MEDIUM”, the entire contents of which are incorporated herein by reference.

### TECHNICAL FIELD

Embodiments of the present disclosure relate to the technical field of image processing, and particularly relate to an image processing method and apparatus, a device, and a storage medium.

### BACKGROUND

Video applications provided in the related art can add effect in a video image so as to improve interestingness of a video. However, there is often a problem that the added effect is not matched with scenes of the video, resulting in that the adding effect of the special effect is reduced and the user experience is poor.

### SUMMARY

In order to solve the above technical problem or at least partially solve the above technical problem, embodiments of the present disclosure provide an image processing method, apparatus, device, and storage medium.

On a first aspect, embodiments of the present disclosure provide an image processing method, including:
acquiring a target image, and acquiring attribute information of sky in the target image;
performing sky segmentation processing on the target image to obtain a sky image in the target image; and
performing corresponding effect processing on the sky image in the target image based on the attribute information.

Optionally, the acquiring the attribute information of the sky in the target image includes:
processing the target image based on a preset identification model to obtain the attribute information of the sky in the target image, the attribute information comprising at least one of weather, time, and type of region.

Optionally, the acquiring the attribute information of the sky in the target image includes:
acquiring at least one of time when the target image is shot by a shooting device, type of region, orientation, and weather at a located position; and
using at least one of the time, the type of region, the orientation, and the weather as the attribute information of the sky.

Optionally, the performing corresponding effect processing on the sky image in the target image based on the attribute information includes:
determining an insert object matched with the attribute information based on the attribute information, the insert object including at least one of image, animation or AR object; and
inserting the insert object to the sky image.

Optionally, the determining the insert object matched with the attribute information based on the attribute information includes:
showing a plurality of candidate objects matched with the attribute information based on the attribute information; and
in response to a selection operation on a candidate object of the plurality of candidate objects, selecting the candidate object as the insert object.

Optionally, after inserting the insert object to the sky image, the method further comprises:
regulating a brightness of the insert object according to a brightness of an insert position, so that the brightness of the insert object is matched with the brightness of an insert position.

Optionally, the inserting the insert object to the sky image includes:
acquiring the insert position on the sky image specified by a user; and
inserting the insert object to the insert position on the sky image specified by the user.

On a second aspect, the present disclosure provides an image processing apparatus, including:
an acquiring unit, configured to acquire a target image and attribute information of sky in the target image;
an image segmenting unit, configured to perform sky segmentation processing on the target image to obtain a sky image in the target image; and
an effect processing unit, configured to perform corresponding effect processing on the sky image in the target image based on the attribute information.

Optionally, the acquiring unit is specifically configured to process the target image based on a preset identification model to obtain the attribute information of the sky in the target image, and the attribute information includes at least one of weather, time, and type of region.

Optionally, the acquiring unit includes:
an attribute acquiring sub-unit, configured to acquire at least one of time when the target image is shot by a shooting device, the type of region, orientation, and weather at a located position; and
an attribute value assigning sub-unit, configured to use at least one of the time, the type of region, the orientation, and the weather as the attribute information of the sky.

Optionally, the effect processing unit includes:
an insert object selecting sub-unit, configured to determine an insert object matched with the attribute information based on the attribute information, the insert object being at least one of image, animation or AR object; and
an adding sub-unit, configured to add the insert object to the sky image.

Optionally, the effect processing unit further comprises:
a showing sub-unit, configured to show a plurality of candidate objects matched with the attribute information; and
a selection detecting sub-unit, configured to, in response to a selection operation on a candidate object of the plurality of candidate objects, use a selected candidate object as the insert object.

Optionally, the apparatus further includes:
a brightness regulating unit, configured to, after the image adding sub-unit adds the insert object to the sky image, regulate a brightness of the insert object according to a brightness of an insert position, so that the brightness of the insert object is matched with the brightness of the insert position.

Optionally, the effect processing unit further comprises an insert position acquiring sub-unit, configured to acquire the insert position on the sky image specified by a user; and
the adding subunit inserts the insert object to the insert position on the sky image specified by the user.

On a third aspect, embodiments of the present disclosure provide a terminal device. The terminal device includes a memory and a processor. A computer program is stored in the memory, and when the computer program is executed by the processor, the methods of the above first aspect can be implemented.

On a fourth aspect, embodiments of the present disclosure provide a computer readable storage medium. The computer program is stored in the storage medium, and when the computer program is executed by a processor, the methods of the above first aspect can be implemented.

Compared to the prior art, the technical solution provided by embodiments of the present disclosure has the following advantages:

In the technical solution provided by embodiments of the present disclosure, attribute information of sky in a target image and a sky image in the target image are acquired, and then corresponding effect processing is performed on the sky image in the target image according to the attribute information so as to ensure that the effect of effect processing is matched with the sky image in the target image and the effect of adding an effect is improved, thereby improving user experience.

### BRIEF DESCRIPTION OF THE DRAWINGS

The accompanying drawings, which are hereby incorporated in and constitute a part of the present description, illustrate embodiments of the present disclosure, and together with the description, serve to explain the principles of the embodiments of the present disclosure

In order to describe the technical solutions in the embodiments of the present disclosure or in the prior art more clearly, the accompanying drawings required in the description of the embodiments or the prior art will be described briefly below. Apparently, other accompanying drawings can also be derived from these drawings by those ordinarily skilled in the art without creative efforts.

FIG. 1 is a flowchart of an image processing method provided by an embodiment of the present disclosure;

FIG. 2 is a target image to be processed provided by one embodiment of the present disclosure;

FIG. 3 is a target image subjected to effect processing and obtained based on FIG. 2;

FIG. 4 is a target image to be processed provided by another embodiment of the present disclosure;

FIG. 5 is a target image subjected to effect processing and obtained based on FIG. 4;

FIG. 6 is a flowchart of an image processing method provided by some other embodiments of the present disclosure;

FIG. 7 is a schematic diagram obtained when an insert object is directly inserted to the target image;

FIG. 8 is a schematic diagram obtained when brightness regulation is performed on the insert object;

FIG. 9 is a structural schematic diagram of an image processing apparatus provided by an embodiment of the present disclosure; and

FIG. 10 is a structural schematic diagram of a terminal device in some embodiments of the present disclosure.

### DETAILED DESCRIPTION

In order to make the above objects, characteristics and advantages of the present disclosure apparent, the technical solutions of the embodiments will be further described below. It should be noted that the embodiments of the present disclosure and the features in the embodiments can be combined with each other in case of no conflict.

In the following description, many specific details are set forth in order to fully understand the present disclosure, but the present disclosure can be implemented in other ways than those described herein; obviously, the embodiments in the specification are only part of the embodiments of the present disclosure, not all of them.

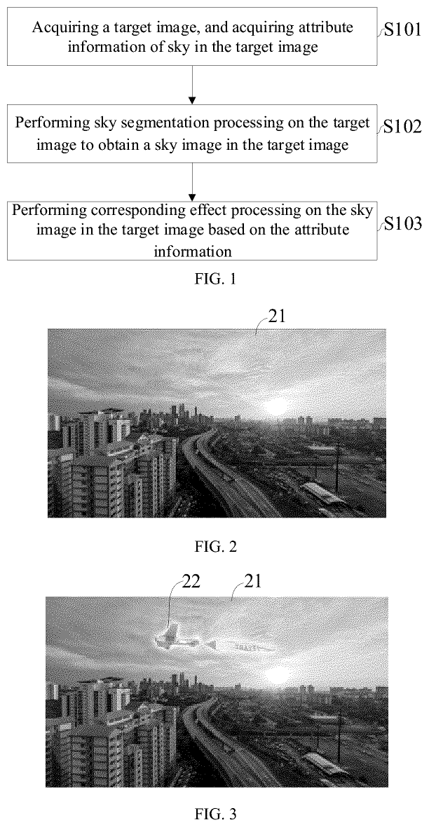

FIG. 1 is a flowchart of an image processing method provided by an embodiment of the present disclosure. The method can be executed by a terminal device. The terminal device can be exemplarily understood as a device with the image processing capacity, such as a smart phone, a tablet computer, a notebook computer, a desktop computer, a smart television, and the like. As shown in FIG. 1, the image processing method provided by the embodiment of the present disclosure includes the steps S101-S103.

S101: acquiring a target image, and acquiring attribute information of sky in the target image.

The target image is an image with a sky pixel content. The target image can be an image stored in a picture format, or can be a frame image in a video file stored in a video mode. In the embodiments of the disclosure, the terminal device can load and obtain the target image from a local memory, or can capture the target image by an image capturing apparatus on the terminal device. It should be noted that the mode of acquiring the target image in the embodiments of the present disclosure is not limited to the above-mentioned modes of loading from the local memory and shooting by the image capturing apparatus, and can also be other modes known in the art.

The attribute information of the sky is information for representing sky features in the target image. The attribute information of the sky can include at least one of weather, time, type of region where it is located, and shooting orientation. For example, the weather can be clear weather, cloudy weather, rainy weather or overcast weather, the time can be morning, forenoon, noon, evening or night, the region where it is located can be city, country or the outdoors, the shooting orientation can be the counter sunlight direction or the front sunlight direction. Certainly, the attribute information of the sky is not limited to the above-mentioned examples, and also can be other attribute information.

In some embodiments of the present disclosure, the step S101 of acquiring the attribute information of the sky in the target image can include: S1011: processing the target image based on a preset identification model to obtain the attribute information of the sky in the target image.

The preset identification model is a model obtained by training a sample image and a corresponding attribute tag. The sample image is an image including the sky, and the attribute tag is a tag made according to the attribute information of the sky in the sample image.

In the specific application, after obtaining the target image, the terminal device firstly processes the target image to obtain the target image with a standard size. Then, the terminal device inputs the target image with the standard size into the preset identification model to obtain the attribute information of the sky in the target image.

In some embodiments of the present disclosure, the attribute information of the sky, which is obtained in the step S1011, can include at least one of weather, time, and type of region where it is located.

In some other embodiments of the present disclosure, the step S101 of acquiring the attribute information of the sky in the target image can include the steps S1012-S1013.

S1012: acquiring at least one of time when the target image is shot by a shooting device, type of region, orientation, and weather at a position where it is located,

S1013: using at least one of the time, the type of region, the orientation, and the weather as the attribute information of the sky.

When shooting the target image by using the image capturing apparatus, the terminal device obtains the above-mentioned information of time, type of region, orientation, or weather, and the like by acquiring detection signals generated by various sensors or by sending a query request to a server.

For example, in some embodiments, the terminal device can acquire position coordinates generated by a positioning apparatus and determine a current region type of the region according to the position coordinates and map information. For another example, in some other embodiments, the terminal device can send a geographic position and time when the target image is shot to a weather server so as to acquire weather determined by the weather server according to the geographic position and the time. For yet another example, the terminal device can acquire a detection signal generated by a magneto-resistive sensor so as to obtain an orientation when the target image is shot.

S102: performing sky segmentation processing on the target image to obtain a sky image in the target image.

Performing sky segmentation processing on the target image to obtain the sky image in the target image refers to identifying a sky and ground boundary in the target image so as to use a pixel image above the sky and ground boundary as the sky image.

In the embodiments of the present disclosure, the terminal device can perform sky segmentation processing on the target image by adopting a pre-trained sky segmenting model so as to obtain the sky image in the target image. The sky segmenting model is a model obtained by training the sample image and a corresponding identification sky area. In some other embodiments of the present disclosure, the terminal device can also obtain the sky image in the target image by other methods known in the art.

S103: performing corresponding effect processing on the sky image in the target image based on the attribute information.

In some embodiments of the present disclosure, the terminal device executes the step S103 of performing corresponding effect processing on the sky image in the target image based on the attribute information specifically can include the steps S1031-S1032.

S1031: determining an insert object matched with the attribute information based on the attribute information.

In some embodiments of the present disclosure, the terminal device pre-stores various insert objects corresponding to the attribute information of the sky, and the insert object can include at least one of image, animation or AR object. For example, a sun image matched with the clear weather, a rain cloud image matched with the rainy weather, and a dark cloud image matched with the overcast weather can be stored in a database of the terminal device. For another example, an aircraft image matched with the daytime clear weather and a firework image matched with the night clear weather can be stored in the database of the terminal device. After the attribute information of the sky is obtained, the terminal device queries the database based on the attribute information, and can determine the insert object matched with the attribute information.

S1032: adding the insert object to the sky image.

After the insert object matched with the attribute information is determined, the terminal device adds the insert object to a sky image area of the target image so as to obtain a target image added with an effect.

FIG. 2 is a target image to be processed provided by one embodiment of the present disclosure, and FIG. 3 is a target image subjected to effect processing and obtained based on FIG. 2. As shown in FIG. 2, a target image 21 is an image of a city in clear weather, and corresponding attribute information of sky includes that time is morning, weather is clear weather, and a type of region is city. The terminal device can determine that an insert object is an airplane image 22 based on the above-mentioned attribute information. Sky segmentation processing is performed on the target image, and an obtained sky image is an upper image in the target image. Finally, the airplane image 22 is added to the sky image in FIG. 2 so as to obtain FIG. 3.

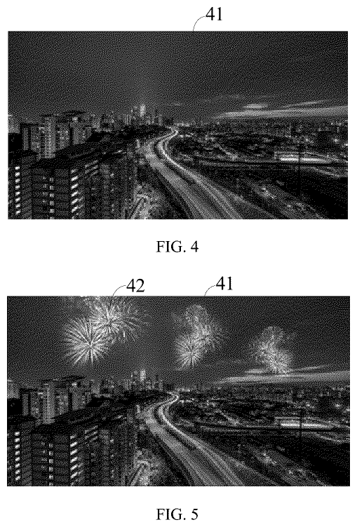

FIG. 4 is a target image to be processed and provided by another embodiment of the present disclosure, and FIG. 5 is a target image subjected to effect processing and obtained based on FIG. 4. As shown in FIG. 4, a target image 41 is an image of a city in clear weather, and corresponding attribute information of sky includes that time is night, weather is clear weather, and a type of region is city. Based on the above-mentioned attribute information, it is determined that an object is a firework image 42. Sky segmentation processing is performed on the target image, and an obtained sky image is an upper image in the target image. Finally, the firework image 42 is added to the sky image in FIG. 4 so as to obtain FIG. 5.

In other embodiments of the present disclosure, the sky image in the target image can also be processed in other effect processing modes, and for example, animation processing is performed on the sky image based on the attribute information, or the brightness, the definition, the color or the saturation of the sky image are regulated based on the attribute information. Certainly, an effect processing method is not limited to the method above, and can also be other methods known in the art.

According to the image processing method provided by the embodiments of the present disclosure, the attribute information of the sky in the target image and the sky image in the target image are acquired, and then corresponding effect processing is performed on the sky image in the target image according to the attribute information so as to ensure that the effect of effect processing is matched with the sky image in the target image and the effect of adding the effect is improved, thereby improving user experience.

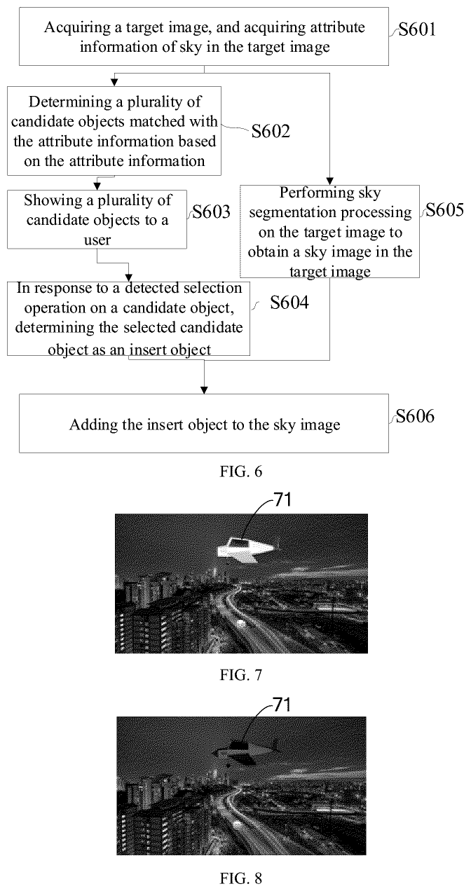

FIG. 6 is a flowchart of an image processing method provided by some other embodiments of the present disclosure. As shown in FIG. 6, in some other embodiments of the present disclosure, an image processing method includes the steps S601-S606.

S601: acquiring a target image, and acquiring attribute information of sky in the target image.

S602: determining a plurality of candidate objects matched with the attribute information based on the attribute information.

S603: showing a plurality of candidate objects to a user.

S604: in response to a detected selection operation on a candidate object, determining the selected candidate object as an insert object.

S605: performing sky segmentation processing on the target image to obtain a sky image in the target image.

S606: adding the insert object to the sky image.

In some embodiments of the present disclosure, in order to improve the diversity of the effect of adding an effect to the target image, for various attribute information of the sky, a plurality of candidate objects matched with the attribute information are stored in the database of the terminal device, and the candidate objects can be at least one of image, animation or AR object.

After the attribute information of the sky in the target image is acquired, the terminal device determines the matched object as the candidate object based on the attribute information. Then, the terminal device shows a plurality of candidate objects to the user by adopting a display apparatus for the user to select. After the selection operation of the user on a certain candidate object is detected, the terminal device uses the selected candidate object as the insert object and inserts the insert object into the sky image.

By adopting the image processing method provided by the embodiments of the present disclosure, the insert object can be selected from a plurality of candidate objects by the user, and then the insert object is inserted to the target image to obtain the target image added with the effect. The insert object is selected and determined by the user, and thus, the obtained target image added with the effect can satisfy requirements of the user better.

In some embodiments of the present disclosure, the step of adding the insert object to the target image can include the steps S6061-S6062.

S6061: acquiring an insert position on the sky image specified by the user.

The insert position specified by the user is configured to indicate a position in the sky image, where the insert object is added. In the embodiments of the present disclosure, the terminal device can prompt the user to perform a clicking selection operation in the sky image so as to obtain the insert position specified by the user.

S6062: adding the insert object to the insert position.

By adding the insert object to the insert position specified by the user, the obtained target image added with the effect can satisfy requirements of the user better.

In some embodiments of the present disclosure, after the aforementioned step S606 of adding the insert object to the target image is performed, the image processing method can further include the step S607.

S607: regulating the brightness of the insert object according to the brightness of the insert position, so that the brightness of the insert object is matched with the brightness of the insert position.

FIG. 7 is a schematic diagram obtained when the insert object is directly inserted to the target image. FIG. 8 is a schematic diagram obtained when the insert object is regulated. As shown in FIG. 7 and FIG. 8, the insert object is an airplane image 71. If the airplane image 71 is directly inserted to the target image without regulating the brightness thereof, as shown in FIG. 7, there is a large difference between the brightness of the airplane image 71 and the brightness of the target image, resulting in that an obtained effect image has a large contrast. As shown in FIG. 8, after the brightness of the airplane image 71 is regulated based on the brightness of the insert position, the brightness of the airplane image 71 is matched with the brightness of the target image, and the effect image has a relatively proper contrast.

In some specific application, the brightness of the insert object is not matched with the brightness at the insert position of the target image. If the insert object is inserted to the sky image without regulation, the finally obtained image contrast is relatively large and unnatural. In order to make the finally obtained image more natural, in the embodiments of the present disclosure, the brightness of the insert object is regulated according to the brightness at the insert position, so that the brightness of the insert object is matched with the brightness of the insert position, and then the finally obtained effect image is more natural.

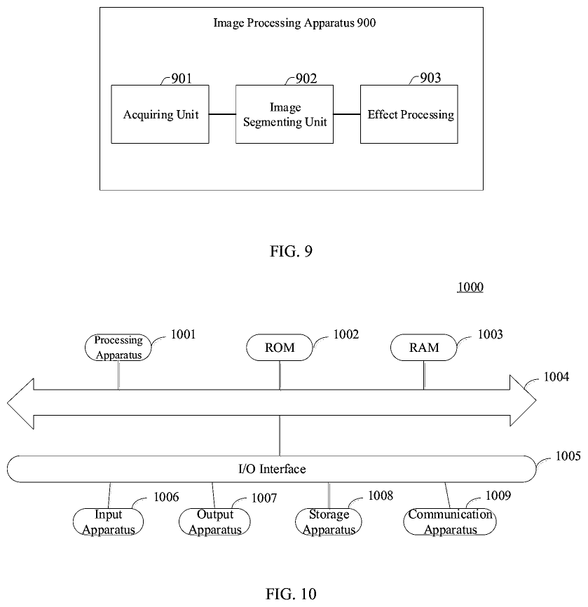

FIG. 9 is a structural schematic diagram of an image processing apparatus provided by an embodiment of the present disclosure. The image processing apparatus can be understood as the above-mentioned terminal device or a partial function module in the above-mentioned terminal device. As shown in FIG. 9, an image processing apparatus 900 includes an acquiring unit 901, an image segmenting unit 902, and an effect processing unit 903.

The acquiring unit 901 is configured to acquire a target image and attribute information of sky in the target image. The image segmenting unit 902 is configured to perform sky segmentation processing on the target image to obtain a sky image in the target image. The effect processing unit 903 is configured to perform corresponding effect processing on the sky image in the target image based on the attribute information.

In some embodiments of the present disclosure, the acquiring unit 901 processes the target image based on a preset identification model to obtain the attribute information of the sky in the target image, and the attribute information includes at least one of weather, time, and type of region where it is located.

In some other embodiments of the present disclosure, the acquiring unit 901 includes an attribute acquiring sub-unit and an attribute value assigning sub-unit. The attribute acquiring sub-unit is configured to acquire at least one of time when the target image is shot by a shooting device, type of region, orientation, and weather at a position where it is located. The attribute value assigning sub-unit is configured to use at least one of the time, the type of region, the orientation, and the weather as the attribute information of the sky.

In some embodiments of the present disclosure, the effect processing unit 903 includes an insert object selecting sub-unit and an adding sub-unit. The insert object selecting sub-unit is configured to determine an insert object matched with the attribute information based on the attribute information; and the insert object includes at least one of image, animation or AR object. The adding sub-unit is configured to add the insert object to the sky image.

In some embodiments of the present disclosure, the image selecting sub-unit determines a plurality of candidate objects matched with the attribute information based on the attribute information. Correspondingly, the effect processing unit 903 further includes a showing sub-unit and a selection detecting sub-unit. The showing sub-unit is configured to show a plurality of candidate objects; and the selection detecting sub-unit is configured to determine a selected candidate object as the insert object in case of detecting a selection operation on the candidate object.

In some embodiments of the present disclosure, the image processing unit further includes a brightness regulating unit. The brightness regulating unit is configured to, after the adding sub-unit adds the insert object to the sky image, regulate the brightness of the insert object according to the brightness of an insert position, so that the brightness of the insert object is matched with the brightness of the insert position.

In some embodiments of the present disclosure, the effect processing unit 903 further includes an insert position acquiring sub-unit. The insert position acquiring sub-unit is configured to acquire the insert position on the sky image specified by a user. The corresponding image adding sub-unit adds the insert object to the insert position.

An embodiment of the present disclosure further provides a terminal device. The terminal device includes a processor and a memory. A computer program is stored in the memory, and when the computer program is executed by the processor, the image processing method provided by any one of the above-mentioned method embodiments can be implemented.

For example, FIG. 10 is a structural schematic diagram of a terminal device in some embodiments of the present disclosure. Specifically referring to FIG. 10 below; it shows a structural schematic diagram of a terminal device 1000 which is applicable to implement the embodiments of the present disclosure. The terminal device 1000 in the embodiments of the present disclosure can include, but be not limited to a mobile terminal (such as a smart phone, a notebook computer, a digital audio broadcasting receiver, a Personal Digital Assistant (PDA), a tablet computer PAD, a Portable Multimedia Player (PMP), a vehicle-mounted terminal (e.g., a vehicle-mounted navigation terminal), and the like) and a fixed terminal such as a digital TV, a desktop computer, and the like. The terminal device shown in FIG. 10 is merely an example and should not have any limitation to the functions and the use scope of the embodiments of the present disclosure.

As shown in FIG. 10, the terminal device 1000 can include a processing apparatus (e.g., a central processing unit, a graphic processing unit, and the like) 1001 which can execute various proper actions and processing according to a program stored in a Read Only Memory (ROM) 1002 or a program loaded into a Random Access Memory (RAM) 1003 from a memory apparatus 1008. In the RAM 1003, various programs and data required for operation of the terminal device 1000 are also stored. The processing apparatus 1001, the ROM 1002, and the RAM 1003 are connected with each other by a bus 1004. An Input/Output (I/O) interface 1005 is also connected to the bus 1004.

Generally, the following apparatuses can be connected to the I/O interface 1005: an input device 1006 including, for example, a touch screen, a touchpad, a keyboard, a mouse, a camera, a microphone, an accelerometer, a gyroscope, and the like; an output device 1007 including, for example, a Liquid Crystal Display (LCD), a loudspeaker, a vibrator, and the like; a memory apparatus 1008 including, for example, a magnetic tape, a hard disk, and the like; and a communication apparatus 1009. The communication apparatus 1009 can allow the terminal device 1000 to perform wireless or wired communication with other devices so as to exchange data. FIG. 10 shows the terminal device 1000 with various apparatuses, but it should be understood that there is no requirement to implement or have all the shown apparatuses. More or fewer apparatuses can be alternatively implemented and equipped.

Particularly, according to the embodiments of the present disclosure, the program described above with reference to the flowchart can be implemented as a computer software program. For example, an embodiment of the present disclosure includes a computer program product including a computer program borne on a non-transient computer readable medium, and the computer program includes a program code for performing the method shown in the flowchart. In such embodiment, the computer program can be downloaded and installed from the internet through the communication device 1009, or installed from the memory apparatus 1008, or installed from the ROM 1002. When the computer program is executed by the processing apparatus 1001, the above-mentioned functions defined in the method provided by the embodiments of the present disclosure are performed.

It should be illustrated that the above-mentioned computer readable medium in the present disclosure can be a computer readable signal medium or a computer readable storage medium or a random combination of both of the above. The computer readable storage medium, for example, can be, but not limited to, an electric, magnetic, optical, electromagnetic, infrared or semiconductor system, apparatus or device, or a random combination of the above. More specific examples of the computer-readable storage medium can include, but are not limited to, an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium can be any tangible medium that contains or stores a program for use by or in combination with an instruction execution system, apparatus or device. While in the present disclosure, the computer-readable signal medium can include data signals propagated in a baseband or as part of a carrier wave, in which computer-readable program codes are carried. Such propagated signals can take a variety of forms, including, but not limited to, an electro-magnetic signal, an optical signal, or any suitable combination thereof. The computer-readable signal medium can also be any computer-readable medium other than a computer-readable storage medium, and the computer-readable signal medium can send, propagate or transmit a program for use by or in combination with an instruction execution system, apparatus or device. Program codes contained on the computer-readable medium can be transmitted using any appropriate medium, including, but not limited to, a wireline, an optical fiber cable, RF (radio frequency), etc., or any suitable combination of the foregoing.

In some embodiments, clients and servers can communicate using any network protocol currently known or to be developed in the future, such as HyperText Transfer Protocol (HTTP), and can be interconnected with any form or medium of digital data communication (such as a communication network). Examples of the communication network include a local area network (LAN), a wide area network (WAN), an internet (such as the Internet), and a peer-to-peer network (such as an Ad-Hoc network), as well as any network currently known or to be developed in the future.

The above computer readable medium can be included in the terminal device, or can exist separately without being assembled in the terminal device.

The above computer readable medium carries one or more programs. When the one or more programs are executed by the terminal device, the terminal device: acquires a target image and acquires attribute information of sky in the target image; performs sky segmentation processing on the target image to obtain a sky image in the target image; and performs corresponding effect processing on the sky image in the target image based on the attribute information.

Computer program codes for performing the operations in the present disclosure can be written in one or more programming languages or combination thereof. The one or more programming languages include, but are not limited to, object-oriented programming languages such as Java, Smalltalk and C++, as well as conventional procedural programming languages such as “C” or similar programming languages. Program codes can be executed entirely on a user computer, executed partly on a user computer, executed as a stand-alone software package, executed partly on a user computer and partly on a remote computer, or executed entirely on a remote computer or a sever. In the case related to the remote computer, the remote computer can be connected to the user computer via any kind of network including a local area network (LAN) or a wide area network (WAN), or can be connected to an external computer (for example, via the Internet through an Internet service provider).

Flowcharts and block diagrams among the accompanying drawings illustrate architectures, functions, and operations possible to implement in accordance with the system, method, and computer program product in various embodiments of the present disclosure. In this regard, each block in the flowcharts or block diagrams can represent a module, a program segment, or part of codes that contains one or more executable instructions for implementing specified logical functions. It is to be noted that in some alternative implementations, functions marked in blocks can occur in an order different from that marked in the accompanying drawings. For example, two successive blocks can, in fact, be executed substantially in parallel or in reverse order, which depends on the functions involved. It is also to be noted that each block in the block diagrams and/or flowcharts and a combination of blocks in the block diagrams and/or flowcharts can be implemented by a special-purpose hardware-based system which executes specified functions or operations, or a combination of special-purpose hardware and computer instructions.

The involved units described in the embodiments of the present disclosure can be implemented by software or hardware. The name of a unit is not intended to limit the unit in a certain circumstance.

The functions described above herein can be executed, at least partially, by one or more hardware logic components. For example, without limitations, example types of hardware logic components that can be used include: a field-programmable gate array (FPGA), an application-specific integrated circuit (ASIC), an application-specific standard product (ASSP), a system on a chip (SOC), a complex programmable logic device (CPLD) and the like.

In the context of the present disclosure, a machine-readable medium can be a tangible medium that can include or store a program used by an instruction execution system, apparatus, or device or used in conjunction with an instruction execution system, apparatus, or device. The machine-readable medium can be a machine-readable signal medium or a machine-readable storage medium. The machine-readable medium can include, but is not limited to, an electronic, magnetic, optical, electromagnetic, infrared, or semiconductor system, apparatus, or device or any suitable combination thereof. More specific examples of the machine-readable storage medium can include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

An embodiment of the present disclosure further provides a computer readable storage medium. A computer program is stored in the storage medium. When the computer program is executed by a processor, the method according to any one of the embodiments in FIGS. 1-8 can be implemented. The execution mode and the beneficial effects are similar and will not be repeated herein.

It should be noted that relational terms such as “first” and “second” are used herein only to distinguish one entity or operation from another, and do not necessarily require or imply any such actual relationship or order between these entities or operations. Furthermore, the term “include”, “comprise” or any other variation thereof is intended to cover non-exclusive inclusion, so that a process, method, article or equipment comprising a set of elements includes not only those elements but also other elements not expressly listed, or elements inherent to such process, method, article or equipment. Without more limitation, an element defined by the sentence “include a . . . ” does not preclude the existence of additional identical elements in a process, method, article or device comprising the element.

The foregoing are only embodiments of this disclosure which enables those skilled in the art to understand or implement this disclosure. Various modifications to these embodiments will be apparent to those skilled in the art, and the general principles defined herein can be implemented in other embodiments without departing from the spirit or scope of this disclosure. Therefore, the disclosure will not be limited to these embodiments described herein, but will conform to the broadest scope consistent with the principles and novel features disclosed herein.

1. An image processing method comprising:
acquiring a target image, and acquiring attribute information of sky in the target image;
performing sky segmentation processing on the target image to obtain a sky image in the target image; and
performing corresponding effect processing on the sky image in the target image based on the attribute information.

2. The method according to claim 1, wherein the acquiring the attribute information of the sky in the target image comprises:
processing the target image based on a preset identification model to obtain the attribute information of the sky in the target image, the attribute information comprising at least one of weather, time, and type of region.

3. The method according to claim 1, wherein the acquiring the attribute information of the sky in the target image comprises:
acquiring at least one of time when the target image is shot by a shooting device, type of region, orientation, and weather at a located position; and
using at least one of the time, the type of region, the orientation, and the weather as the attribute information of the sky.

4. The method according to claim 1, wherein the performing corresponding effect processing on the sky image in the target image based on the attribute information comprises:
determining an insert object matched with the attribute information based on the attribute information, the insert object comprising at least one of an image, animation or AR object; and
inserting the insert object to the sky image.

5. The method according to claim 4, wherein the determining the insert object matched with the attribute information based on the attribute information comprises:
showing a plurality of candidate objects matched with the attribute information based on the attribute information; and
selecting a candidate object of the plurality of candidate objects as the insert object, in response to a selection operation on the candidate object.

6. The method according to claim 4, wherein after inserting the insert object to the sky image, the method further comprises:
regulating a brightness of the insert object according to a brightness of an insert position, so that the brightness of the insert object is matched with the brightness of the insert position.

7. The method according to claim 4, wherein the inserting the insert object to the sky image comprises:
acquiring the insert position on the sky image specified by a user; and
inserting the insert object to the insert position on the sky image specified by the user.

8. An image processing apparatus, comprising:
an acquiring unit, configured to acquire a target image and attribute information of sky in the target image;
an image segmenting unit, configured to perform sky segmentation processing on the target image to obtain a sky image in the target image; and
an effect processing unit, configured to perform corresponding effect processing on the sky image in the target image based on the attribute information.

9. The apparatus according to claim 8, wherein
the acquiring unit is specifically configured to process the target image based on a preset identification model to obtain the attribute information of the sky in the target image, and the attribute information comprises at least one of weather, time, and type of region.

10. The apparatus according to claim 8, wherein the acquiring unit comprises:
an attribute acquiring sub-unit, configured to acquire at least one of time when the target image is shot by a shooting device, type of region, orientation, and weather at a located position; and
an attribute value assigning sub-unit, configured to use at least one of the time, the type of region, the orientation, and the weather as the attribute information of the sky.

11. The apparatus according to claim 8, wherein the effect processing unit comprises:
an insert object selecting sub-unit, configured to determine an insert object matched with the attribute information based on the attribute information, the insert object comprising at least one of image, animation or AR object; and
an adding sub-unit, configured to add the insert object to the sky image.

12. The apparatus according to claim 11, wherein the effect processing unit further comprises:
a showing sub-unit, configured to show a plurality of candidate objects matched with the attribute information; and
a selection detecting sub-unit, configured to, in response to a selection operation on a candidate object of the plurality of candidate objects, select the candidate object as the insert object.

13. The apparatus according to claim 11, further comprising:
a brightness regulating unit, configured to, after the image adding sub-unit adds the insert object to the sky image, regulate a brightness of the insert object according to a brightness of an insert position, so that the brightness of the insert object is matched with the brightness of the insert position.

14. The apparatus according to claim 11, wherein
the effect processing unit further comprises an insert position acquiring sub-unit, configured to acquire the insert position on the sky image specified by a user; and
the adding subunit inserts the insert object to the insert position on the sky image specified by the user.

15. A terminal device, comprising:
a memory and a processor, wherein a computer program is stored in the memory, and when the computer program is executed by the processor, an image processing method is implemented, the method comprises:
acquiring a target image, and acquiring attribute information of sky in the target image;
performing sky segmentation processing on the target image to obtain a sky image in the target image; and
performing corresponding effect processing on the sky image in the target image based on the attribute information.

16. A computer readable storage medium, wherein a computer program is stored in the storage medium, and when the computer program is executed by a processor, the method according to claim 1 is implemented.

17. The method according to claim 5, wherein after inserting the insert object to the sky image, the method further comprises: regulating a brightness of the insert object according to a brightness of an insert position, so that the brightness of the insert object is matched with the brightness of the insert position.

18. The method according to claim 5, wherein the inserting the insert object to the sky image comprises: acquiring the insert position on the sky image specified by a user; and inserting the insert object to the insert position on the sky image specified by the user.

19. The apparatus according to claim 12, further comprising: a brightness regulating unit, configured to, after the image adding sub-unit adds the insert object to the sky image, regulate a brightness of the insert object according to a brightness of an insert position, so that the brightness of the insert object is matched with the brightness of the insert position.

20. The apparatus according to claim 12, wherein the effect processing unit further comprises an insert position acquiring sub-unit, configured to acquire the insert position on the sky image specified by a user; and the adding subunit inserts the insert object to the insert position on the sky image specified by the user.
